(19) United States
(12) Patent Application Publication
(10) Pub. No.: US 2021/0237715 A1
(43) Pub. Date: Aug. 5, 2021

(54) CONTINUOUS INPUT BRAIN MACHINE INTERFACE FOR AUTOMATED DRIVING FEATURES

(71) Applicant: Ford Global Technologies, LLC, Dearborn, MI (US)

(72) Inventors: Ali Hassani, Ann Arbor, MI (US); Aniruddh Ravindran, Sunnyvale, CA (US); Vijay Nagasamy, Fremont, CA (US)

(73) Assignee: Ford Global Technologies, LLC, Dearborn, MI (US)

(21) Appl. No.: 16/776,970

(22) Filed: Jan. 30, 2020

(51) Int. Cl. B60W 30/06; G06F 3/01; B62D 15/02; B60W 60/00; G06F 17/15

(52) U.S. Cl. CPC B60W 30/06; G06F 3/015; G06F 17/15; B60W 60/0027; B62D 15/0285

(57) ABSTRACT

Embodiments describe a vehicle configured with a brain machine interface (BMI) for a vehicle computing system to control vehicle functions using electrical impulses from motor cortex activity in a user's brain. A BMI training system trains the BMI device to interpret neural data generated by a motor cortex of a user and correlates the neural data to a vehicle control command associated with a neural gesture emulation function. A BMI system onboard the vehicle may receive a continuous neural data feed of neural data from the user using the trained BMI device, determine a user intention for a control instruction to control a vehicle system using the continuous neural data feed, and perform an action based on the control instruction. A user may control aspects of automated parking using the BMI device in conjunction with a vehicle controller that governs some aspects of the parking operation.

### TECHNICAL FIELD

The present disclosure relates to brain-machine interfaces, and more particularly, to command of a semi-autonomous vehicle function.

### BACKGROUND

Brain machine interface (BMI) is a technology that enables humans to provide commands to computers using human brain activity. BMI systems provide control input by interfacing an electrode array with the motor cortex region of the brain, either externally or internally, and decoding the activity signals using a trained neural decoder that translates neuron firing patterns in the user's brain into discrete vehicle control commands.

BMI interfaces can include either invasive direct-contact electrode interface techniques that work with internal direct contact with motor cortex regions, or include non-invasive electrode interface techniques, where wireless receivers utilize sensors to measure electrical activity of the brain to determine actual as well as potential electrical field activity using functional magnetic resonance imaging MRI (fMRI), electroencephalography (EEG), or electric field encephalography (EFEG) receivers that may externally touch the scalp, temples, forehead, or other areas of the user's head. BMI systems generally work by sensing the potentials or potential electrical field activity, amplifying the data, and processing the signals through a digital signal processor to associate stored patterns of brain neural activity with functions that may control devices or provide some output using the processed signals. Recent advancements in BMI technology have contemplated aspects of vehicle control using BMIs.

A BMI system used to control a vehicle using EFEG is disclosed in Korean Patent Application Publication No. KR101632830 (hereafter “the '830 publication), which describes recognition of control bits obtained from an EFEG apparatus for drive control of a vehicle. While the system described in the '830 publication may use some aspects of EFEG data for vehicle signal control, the '830 publication does not disclose a BMI integrated semi-autonomous vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example computing environment in which techniques and structures for providing the systems and methods disclosed herein may be implemented.

FIG. 2 illustrates a functional schematic of an example architecture of an automotive control system for use with the vehicle, in accordance with the present disclosure.

FIG. 3A illustrates an example BMI training system in accordance with an embodiment of the present disclosure.

FIGS. 3B-3E illustrate various aspects of a sequence for an example BMI training system in accordance with an embodiment of the present disclosure.

FIG. 4 depicts a functional block diagram 400 of the BMI system 107 in accordance with an embodiment the present disclosure.

FIG. 5 depicts a flow diagram in accordance with the present disclosure.

FIG. 6 depicts an example output determination, according to the present disclosure.

FIG. 7 is a flow diagram of an example method for controlling a vehicle using the BMI system 107, according to the present disclosure.

### DETAILED DESCRIPTION

### Overview

The disclosed systems and methods describe a BMI system implemented in a vehicle. In some embodiments, a user may exercise control over some driving functionality such as vehicle speed or direction control using the BMI system to read electrical impulses from the motor cortex of the user's brain, decode a continuous neural data feed, and issue vehicle control commands in real time or substantially real time. The BMI system can include integrated logic that evaluates a user's mental attention on the driving operation at hand by evaluating the user's focus quantified as a user engagement value, and govern aspects of the driving operation using an autonomous vehicle controller. Some embodiments describe driving operations that include aspects of Level-2 or Level-3 autonomous driving control, where the user performs some aspects of vehicle operation. In one embodiment, the driving operation is an automated parking procedure.

According to embodiments of the present disclosure, the BMI system may include an EEG system configured to receive electric potential field signatures from the motor cortex of the user's brain using scalp-to-electrode external physical contacts that read and process the signals. In other aspects, the electrodes may be disposed proximate the user's scalp without physical external contact with the scalp surface, but within a relatively short operative range in terms of physical distance for signal collection and processing. In an embodiment, the brain-machine interface device may include a headrest in a vehicle configured to receive EEG signals.

A BMI training system trains the BMI device to interpret neural data generated by a motor cortex of a user by correlating the neural data to a vehicle control command associated with a neural gesture emulation function. The trained BMI device may be disposed onboard the vehicle, to receive a continuous neural data feed of neural data from the user (when the user is physically present in the vehicle). The BMI device may determine a user's intention for a control instruction that assists the driver in controlling the vehicle. More particularly, the BMI device may receive the continuous data feed of neural data from the user, and determine, from the continuous data feed of neural data, a user's intention for an automated driving control function or more specifically a Driver Assist Technologies (DAT) control function. The BMI device generates a control instruction derived from the DAT control function, and sends the instruction to the DAT controller onboard the vehicle, where the DAT controller executes the DAT control function. One embodiment describes a semi-autonomous vehicle operation state where the user controls aspects of automated parking using the BMI device in conjunction with the DAT controller that governs some aspects of the parking operation.

Embodiments of the present disclosure may provide for additional granularity of user control when interacting with a semi-autonomous vehicle, where users may exercise some discrete manual control aspects that are ultimately governed by the DAT controller. Embodiments of the present disclosure may provide convenience and robustness for BMI control systems.

These and other advantages of the present disclosure are provided in greater detail herein.

### Illustrative Embodiments

The disclosure will be described more fully hereinafter with reference to the accompanying drawings, in which exemplary embodiments of the disclosure are shown, and not intended to be limiting.

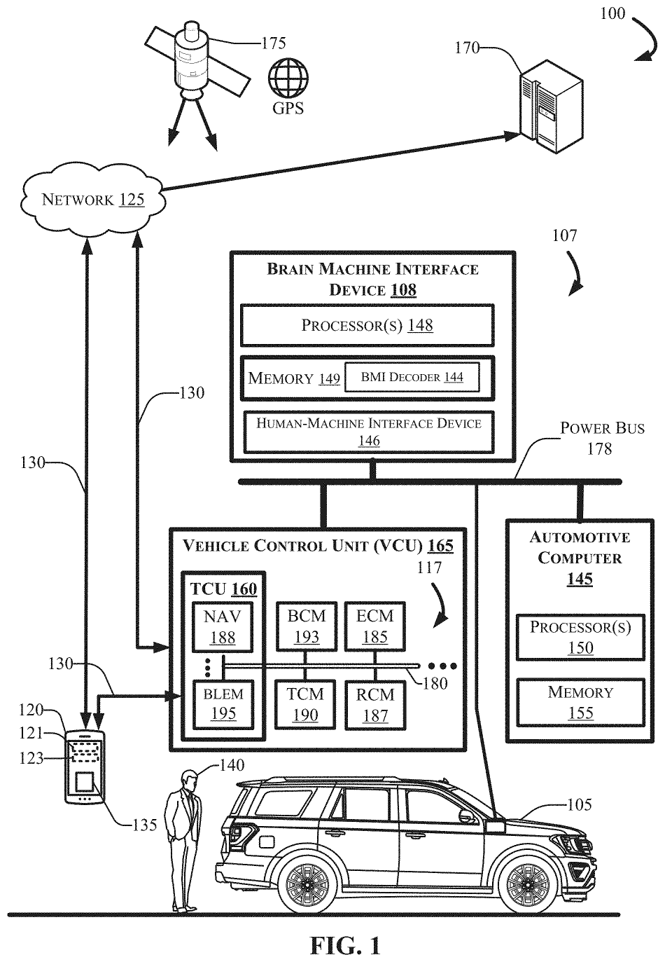

FIG. 1 depicts an example computing environment 100 that can include one or more vehicle(s) 105 comprising an automotive computer 145, and a Vehicle Control Unit (VCU) 165 that typically includes a plurality of electronic control units (ECUs) 117 disposed in communication with the automotive computer 145 and a Brain Machine Interface (BMI) device 108. A mobile device 120, which may be associated with a user 140 and the vehicle 105, may connect with the automotive computer 145 using wired and/or wireless communication protocols and transceivers. The mobile device 120 may be communicatively coupled with the vehicle 105 via one or more network(s) 125, which may communicate via one or more wireless channel(s) 130, and/or may connect with the vehicle 105 directly using near field communication (NFC) protocols, Bluetooth® protocols, Wi-Fi, Ultra-Wide Band (UWB), and other possible communication techniques. The vehicle 105 may also receive location information from a Global Positioning System (GPS) 175.

The mobile device 120 generally includes a memory 123 for storing program instructions associated with an application 135 that, when executed by a mobile device processor 121, performs aspects of the present disclosure. The application 135 may be part of the BMI system 107, or may provide information to the BMI system 107 and/or receive information from the BMI system 107.

The automotive computer 145 generally refers to a vehicle control computing system, which may include one or more processor(s) 150 and memory 155. The automotive computer 145 may, in some example embodiments, be disposed in communication with the mobile device 120, and one or more server(s) 170, which may be associated with and/or include connectivity with a Telematics Service Delivery Network (SDN).

Although illustrated as a sport utility, the vehicle 105 may take the form of another passenger or commercial automobile such as, for example, a car, a truck, a sport utility, a crossover vehicle, a van, a minivan, a taxi, a bus, etc. In an example powertrain configuration, the vehicle 105 may include an internal combustion engine (ICE) powertrain having a gasoline, diesel, or natural gas-powered combustion engine with conventional drive components such as, a transmission, a drive shaft, a differential, etc. In another example configuration, the vehicle 105 may include an electric vehicle (EV) drive system. More particularly, the vehicle 105 may include a battery EV (BEV) drive system, or be configured as a hybrid EV (HEV) having an independent onboard powerplant, and/or may be configured as a plug-in HEV (PHEV) that is configured to include a HEV powertrain connectable to an external power source. The vehicle 105 may be further configured to include a parallel or series HEV powertrain having a combustion engine powerplant and one or more EV drive systems that can include battery power storage, supercapacitors, flywheel power storage systems, and other types of power storage and generation. In other aspects, the vehicle 105 may be configured as a fuel cell vehicle (FCV) where the vehicle 105 is powered by a fuel cell, a hydrogen FCV, a hydrogen fuel cell vehicle powertrain (HFCV), and/or any combination of these drive systems and components.

Further, the vehicle 105 may be a manually driven vehicle, and/or be configured to operate in a fully autonomous (e.g., driverless) mode (e.g., level-5 autonomy) or in one or more partial autonomy modes. Examples of partial autonomy modes are widely understood in the art as autonomy Levels 1 through 5. By way of a brief overview, a DAT having Level 1 autonomy may generally include a single automated driver assistance feature, such as steering or acceleration assistance. Adaptive cruise control is one such example of a Level-1 autonomous system that includes aspects of both acceleration and steering. Level-2 autonomy in vehicles may provide partial automation of steering and acceleration functionality, where the automated system(s) are supervised by a human driver that performs non-automated operations such as braking and other controls. Level-3 autonomy in a vehicle can generally provide conditional automation and control of driving features. For example, Level-3 vehicle autonomy typically includes “environmental detection” capabilities, where the vehicle can make informed decisions independently from a present driver, such as accelerating past a slow-moving vehicle, while the present driver remains ready to retake control of the vehicle if the system is unable to execute the task. Level 4 autonomy includes vehicles having high levels of autonomy that can operate independently from a human driver, but still includes human controls for override operation. Level-4 automation may also enable a self-driving mode to intervene responsive to a predefined conditional trigger, such as a road hazard or a system failure. Level 5 autonomy is associated with fully autonomous vehicle systems that require no human input for operation, and generally do not include human operational driving controls.

According to an embodiment, the BMI system 107 may be configured to operate with a vehicle having a Level-1 to Level-4 semi-autonomous vehicle controller. Accordingly, the BMI system 107 may provide some aspects of human control to the vehicle 105.

In some aspects, the mobile device 120 may communicate with the vehicle 105 through the one or more wireless channel(s) 130, which may be encrypted and established between the mobile device 120 and a Telematics Control Unit (TCU) 160. The mobile device 120 may communicate with the TCU 160 using a wireless transmitter associated with the TCU 160 on the vehicle 105. The transmitter may communicate with the mobile device 120 using a wireless communication network such as, for example, the one or more network(s) 125. The wireless channel(s) 130 are depicted in FIG. 1 as communicating via the one or more network(s) 125, and also via direct communication with the vehicle 105.

The network(s) 125 illustrate an example of one possible communication infrastructure in which the connected devices may communicate. The network(s) 125 may be and/or include the Internet, a private network, public network or other configuration that operates using any one or more known communication protocols such as, for example, transmission control protocol/Internet protocol (TCP/IP), Bluetooth®, Wi-Fi based on the Institute of Electrical and Electronics Engineers (IEEE) standard 802.11, Ultra-Wide Band (UWB), and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The automotive computer 145 may be installed in an engine compartment of the vehicle 105 (or elsewhere in the vehicle 105) and operate as a functional part of the BMI system 107, in accordance with the disclosure. The automotive computer 145 may include one or more processor(s) 150 and a computer-readable memory 155. The automotive computer 145 may include, in one example, the one or more processor(s) 150, and the computer-readable memory 155.

The BMI device 108 may be disposed in communication with the VCU 165, and may be configured to provide (in conjunction with the VCU 165) system-level and device-level control of the vehicle 105. The VCU 165 may be disposed in communication with and/or be a part of the automotive computer 145, and may share a common power bus 178 with the automotive computer 145 and the BMI system 107. The BMI device 108 may further include one or more processor(s) 148, a memory 149 disposed in communication with the processor(s) 148, and a Human-Machine Interface (HMI) device 146 configured to interface with the user 140 by receiving motor cortex brain signals as the user assists in operating the vehicle using the BMI device 108.

The one or more processor(s) 148 and/or 150 may be disposed in communication with a respective one or more memory devices associated with the respective computing systems (e.g., with the memory 149, the memory 155 and/or one or more external databases not shown in FIG. 1). The processor(s) 148, 150 may utilize the memory(s) 149, 155 to store programs in code and/or to store data for performing aspects in accordance with the disclosure. The memory 149 may include non-transitory computer-readable memory storing a BMI decoder 144. The memory(s) 149 and 155 can include any one or a combination of volatile memory elements (e.g., dynamic random access memory (DRAM), synchronous dynamic random access memory (SDRAM), etc.) and can include any one or more nonvolatile memory elements, including an erasable programmable read-only memory (EPROM), flash memory, electronically erasable programmable read-only memory (EEPROM), programmable read-only memory (PROM), etc.

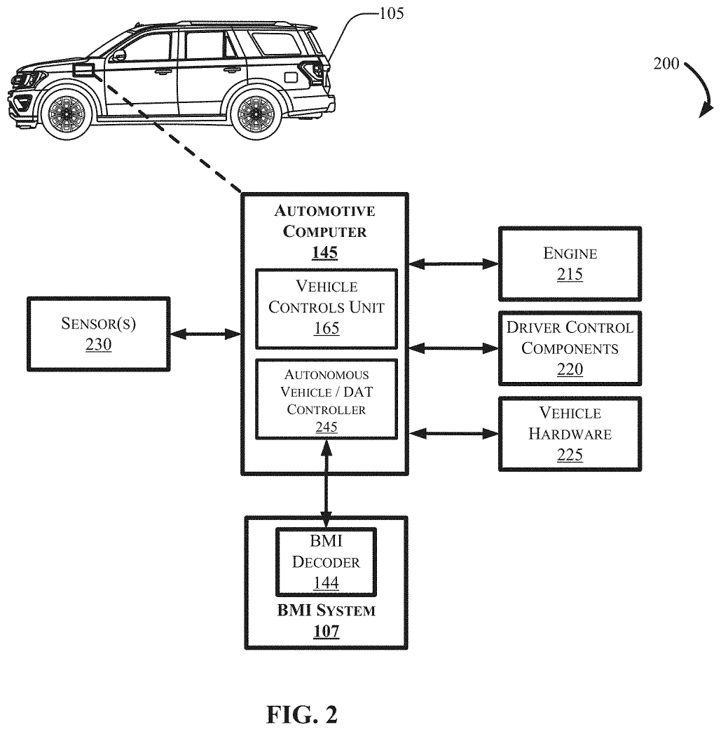

The VCU 165 can include any combination of the ECUs 117, such as, for example, a Body Control Module (BCM) 193, an Engine Control Module (ECM) 185, a Transmission Control Module (TCM) 190, the TCU 160, a Restraint Control Module (RCM) 187, etc. In some aspects, the ECUs 117 may control aspects of the vehicle 105, and implement one or more instruction sets received from the application 135 operating on the mobile device 120, from one or more instruction sets received from the BMI device 108, and/or from instructions received from a driver assistance controller (e.g., a DAT controller 245 discussed with respect to FIG. 2.

For example, the DAT controller 245 may receive an instruction from the BMI device 108 associated with automated vehicle maneuvers such as parking, automatic trailer hitching, and other utilities where the user 140 provides an instruction to the BMI device 108 using thought inputs, and further provides a user engagement indicator input that informs the DAT controller 245 whether the user 140 is sufficiently engaged with the vehicle control operation at hand. In an example, the user 140 may provide a continuous data feed of neural data that includes neural cortex activity associated with a mental representation of a repeating body gesture performed by the user 140. The BMI system 107 determines that the digital representation of the repeating body gesture conforms to a canonical model of that gesture, and generates a user engagement value responsive to determining that the user is sufficiently engaged with the operation. Various example processes are discussed in greater detail hereafter.

The TCU 160 may be configured to provide vehicle connectivity to wireless computing systems onboard and offboard the vehicle 105. The TCU 160 may include transceivers and receivers that connect the vehicle 105 to networks and other devices, including, for example, a Navigation (NAV) receiver 188 that may receive GPS signals from the GPS system 175, and/or a Bluetooth® Low-Energy Module (BLEM) 195, Wi-Fi transceiver, Ultra-Wide Band (UWB) transceiver, and/or other control modules configurable for wireless communication between the vehicle 105 and other systems, computers, and modules. The TCU 160 may also provide communication and control access between ECUs 117 using a Controller Area Network (CAN) bus 180, by retrieving and sending data from the CAN bus 180, and coordinating the data between vehicle 105 systems, connected servers (e.g., the server(s) 170), and other vehicles (not shown in FIG. 1) operating as part of a vehicle fleet.

The BLEM 195 may establish wireless communication using Bluetooth® communication protocols by broadcasting and/or listening for broadcasts of small advertising packets, and establishing connections with responsive devices that are configured according to embodiments described herein. For example, the BLEM 195 may include Generic Attribute Profile (GATT) device connectivity for client devices that respond to or initiate GATT commands and requests.

The CAN bus 180 may be configured as a multi-master serial bus standard for connecting two ECUs as nodes using a message-based protocol that can be configured and/or programmed to allow the ECUs 117 to communicate with each other. The CAN bus 180 may be or include a high speed CAN (which may have bit speeds up to 1 Mb/s on CAN, 5 Mb/s on CAN Flexible Data Rate (CAN FD)), and can include a low speed or fault tolerant CAN (up to 125 Kbps), which may, in some configurations, use a linear bus configuration. In some aspects, the ECUs 117 may communicate with a host computer (e.g., the automotive computer 145, the BMI system 107, and/or the server(s) 170, etc.), and may also communicate with one another without the necessity of a host computer. The CAN bus 180 may connect the ECUs 117 with the automotive computer 145 such that the automotive computer 145 may retrieve information from, send information to, and otherwise interact with the ECUs 117 to perform steps described according to embodiments of the present disclosure. The CAN bus 180 may connect CAN bus nodes (e.g., the ECUs 117) to each other through a two-wire bus, which may be a twisted pair having a nominal characteristic impedance. The CAN bus 180 may also be accomplished using other communication protocol solutions, such as Media Oriented Systems Transport (MOST) or Ethernet. In other aspects, the CAN bus 180 may be a wireless intra-vehicle CAN bus.

The ECUs 117, when configured as nodes in the CAN bus 180, may each include a central processing unit, a CAN controller, and a transceiver (not shown in FIG. 1). In an example embodiment, the ECUs 117 may control aspects of vehicle operation and communication based on inputs from human drivers, the DAT controller 245, the BMI system 107, and via wireless signal inputs received from other connected devices such as the mobile device 120, among others.

The VCU 165 may control various loads directly via the CAN bus 180 communication or implement such control in conjunction with the BCM 193. The ECUs 117 described with respect to the VCU 165 are provided for exemplary purposes only, and are not intended to be limiting or exclusive. Control and/or communication with other control modules not shown in FIG. 1 is possible, and such control is contemplated.

The BCM 193 generally includes integration of sensors, vehicle performance indicators, and variable reactors associated with vehicle systems, and may include processor-based power distribution circuitry that can supervise and control functions related to the car body such as lights, windows, security, door locks and access control, and various comfort controls. The central BCM 193 may also operate as a gateway for bus and network interfaces to interact with remote ECUs (not shown in FIG. 1).

The BCM 193 may coordinate any one or more functions from a wide range of vehicle functionality, including energy management systems, alarms, vehicle immobilizers, driver and rider access authorization systems, Phone-as-a-Key (PaaK) systems, driver assistance systems, DAT control systems, power windows, doors, actuators, and other functionality, etc. The BCM 193 may be configured for vehicle energy management, exterior lighting control, wiper functionality, power window and door functionality, heating ventilation and air conditioning systems, and driver integration systems. In other aspects, the BCM 193 may control auxiliary equipment functionality, and/or be responsible for integration of such functionality. In one aspect, a vehicle having a trailer control system may integrate the system using, at least in part, the BCM 193.

The computing system architecture of the automotive computer 145, VCU 165, and/or the BMI system 107 may omit certain computing modules. It should be readily understood that the computing environment depicted in FIG. 1 is one example of a possible implementation according to the present disclosure, and thus, it should not be considered limiting or exclusive.

FIG. 2 illustrates a functional schematic of an example architecture of an automotive control system 200 that may be used for control of the vehicle 105, in accordance with the present disclosure. The control system 200 may include the BMI system 107, which may be disposed in communication with the automotive computer 145, and vehicle control hardware including, for example, an engine/motor 215, driver control components 220, vehicle hardware 225, sensor(s) 230, and the mobile device 120 and other components not shown in FIG. 2.

The sensors 230 may include any number of devices configured or programmed to generate signals that help navigate the vehicle 105 when it is operating in a semi-autonomous mode. Examples of autonomous driving sensors 230 may include a Radio Detection and Ranging (RADAR or “radar”) sensor configured for detection and localization of objects using radio waves, a Light Detecting and Ranging (LiDAR or “lidar”) sensor, a vision sensor system having trajectory, obstacle detection, object classification, augmented reality, and/or other capabilities, and/or the like. The autonomous driving sensors 230 may help the vehicle 105 “see” the roadway and the vehicle surroundings and/or negotiate various obstacles while the vehicle is operating in the autonomous mode.

The vehicle 105, in the embodiment depicted in FIG. 2, may be a Level-2, Level 3, or Level 4 AV. The automotive computer 145 may be controlled using the DAT controller 245, and may further control input from the BMI system 107 that operates the BMI decoder 144 via the BMI device 108, operates a continuous data feed of neural data from a user (e.g., the user 140), and determines a user intention for a vehicle control instruction from the continuous neural data feed.

Interpreting neural data from the motor cortex of a user's brain is possible when the BMI device 108 is trained and tuned to a particular user's neural activity. The training procedures can include systematically mapping a continuous neural data feed obtained from that user, where the data feed provides quantitative values associated with user brain activity as the user provides manual input into a training computer system, and more particularly, as the user provides control of a pointer. The training computer system may form associations for patterns of neural cortex activity (e.g., a correlation model) as the user performs exercises associated with vehicle operation by controlling the pointer, and generating a correlation model that can process continuous data feed and identify neural cortex activity that is associated with control functions.

The BMI decoder 144 may determine, from the continuous data feed of neural data, a user intention for a semi-autonomous or driver assist command control function by matching the user intention to a DAT control function. The BMI system 107 may use a trained correlation model (not shown in FIG. 2) to form such an association, and further evaluate the continuous data feed of neural data to determine a user engagement value. The user engagement value, when it meets a predetermined threshold, can indicate that the user's mind is sufficiently engaged on the control task at hand. The BMI system 107 may send the instruction to the DAT controller 245 to execute the first vehicle control function, responsive to a determination that the user engagement value at least satisfies the threshold value. Accordingly, when configured with the trained BMI device that uses the trained correlation model, the DAT controller 245 may provide vehicle control by performing some aspects of vehicle operation autonomously, and provide other aspects of vehicle control to the user through the trained BMI system 107.

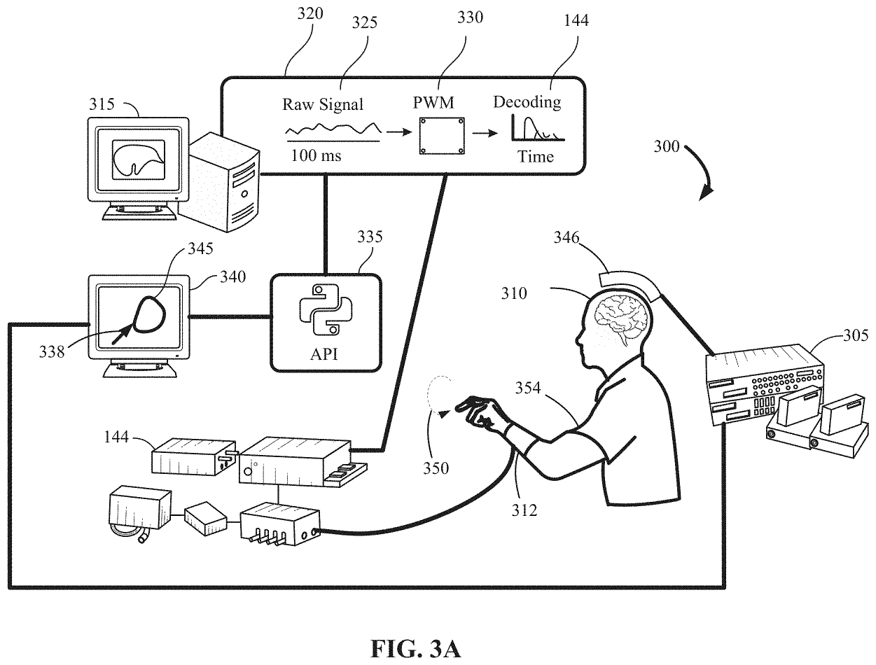

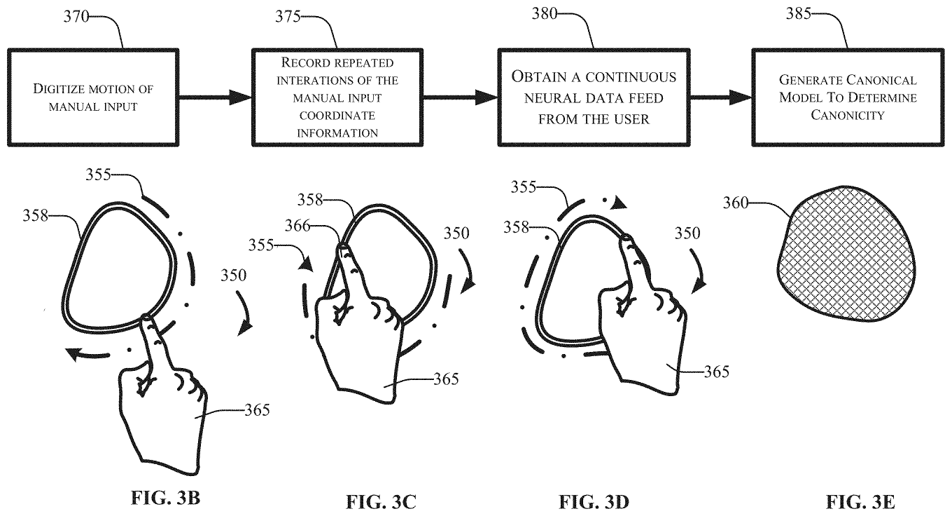

FIG. 3A illustrates an example BMI training system 300, in accordance with an embodiment of the present disclosure. The BMI training system 300 may include a neural data acquisition system 305, a training computer 315 with digital signal processing (DSP) decoding, and an application programming interface (API) 335.

By way of a brief overview, the following paragraphs will provide a general description for an example method of training the BMI system 107 using the BMI training system 300. In one aspect, a user 310 may interact with a manual input device 312 and provide inputs to the BMI training system. The BMI training system 300 may generate a decoding model, based on the user inputs, for interpreting neural cortex brain activity associated with this particular user. For example, the BMI training system 300 may present a pointer 338 on a display device of a training computer 340. The user 310 may provide manual input using the manual input device 312, where the manual input includes moving the pointer 338 on the display device of the training computer 340. In one aspect, the user 310 may provide these manual control inputs while operating a driving simulation program (not shown in FIG. 3A). While the user 310 performs the manual inputs, The BMI training system 300 may also obtain the neural data using the neural data acquisition system 305. The BMI training system 300 may collect the neural data (e.g., raw data input) and perform a comparison procedure whereby the user 310 performs imagined movements of the user body gesture 350 (which may include imagining use of an input arm 354), and where the imagined inputs can include a hand close, a hand open, a forearm pronation, a forearm supination, and finger flexion. Some embodiments may include performing the comparison procedure while the neural data acquisition system 305 obtains raw signal data from a continuous neural data feed indicative of brain activity of the user 310.

Obtaining the continuous neural data feed may include receiving, via the training computer 340, neural data input as a time series of decoder values from a microelectrode array 346. For example, the neural data acquisition system 305 may obtain the neural data by sampling the continuous data feed at a predetermined rate (e.g., 4 decoder values every 100 ms, 2 decoder values every 100 ms, 10 decoder values every 100 ms, etc.). The BMI training system 300 may generate a correlation model (not shown in FIG. 3) that correlates the continuous neural data feed to a fuzzy state associated with a first vehicle control function. The BMI training system may save the decoder values 325 to a computer memory 330, then convert the decoder values to motor cortex mapping data using pulse width modulation and other DSP techniques via a digital signal processor 320. The BMI decoder 144 may map data to aspects of vehicle control, such as, for example, velocity and steering control commands.

The user 310 may be the same user as shown in FIG. 1, who may operate the vehicle with the trained BMI system 107, where the training procedure is specific to that particular user. In another aspect, the training procedure may provide a correlation model that correlates the continuous neural data feed to fuzzy states associated with vehicle control functions, where the generalized correlation model applies a generalized neural cortex processing function to a wider array of possible neural patterns. In this respect, the generalized model may be readily adopted by any user with some limited tuning and training. One method contemplated to produce a generalized model may include, for example, the use of machine learning techniques that include deep neural network correlation model development.

The microelectrode array 346 may be configured to obtain neural data from the primary motor cortex of a user 310 which data were acquired through an invasive or non-invasive neural cortex connection. For example, in one aspect, an invasive approach to neural data acquisition may include an implanted 96-channel intracortical microelectrode array configured to communicate through a port interface (e.g., a NeuroPort® interface, currently available through Blackrock Microsystems, Salt Lake, Utah). In another example embodiment, using a non-invasive approach, the microelectrode array 346 may include a plurality of wireless receivers that wirelessly measure brain potential electrical fields using an electric field encephalography (EFEG) device.

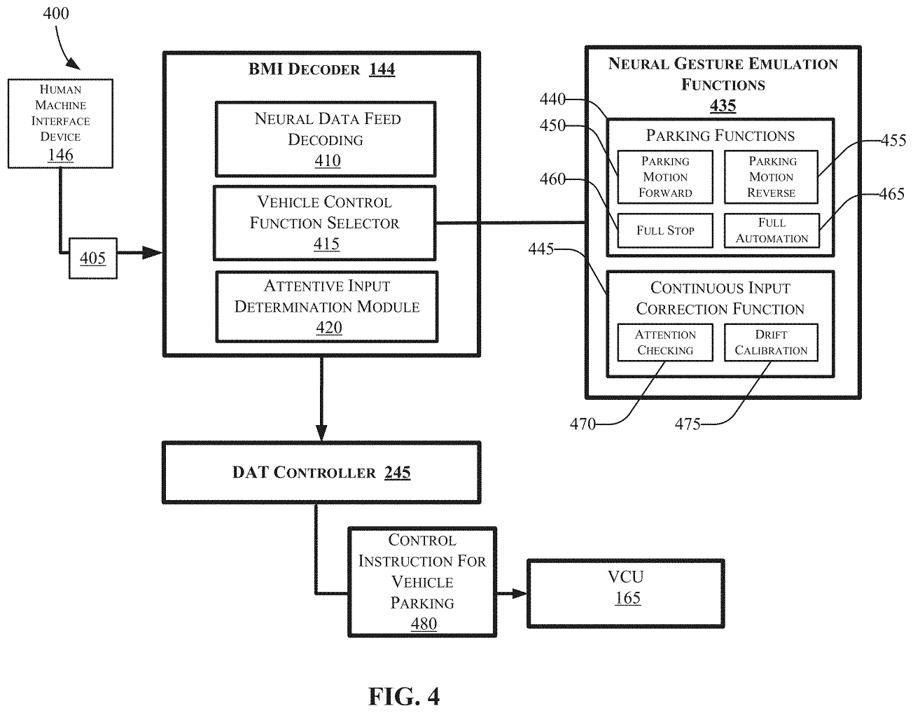

The training computer 315 may receive the continuous neural data feed via wireless or wired connection (e.g., using an Ethernet to PC connection) from the neural data acquisition system 305. The training computer 315 may be, in one example embodiment, a workstation running a MATLAB®-based signal processing and decoding algorithm. Other math processing and DSP input software are possible and contemplated. The BMI training system may generate the correlation model that correlates the continuous neural data feed to the fuzzy states associated with the vehicle control functions (described in greater detail with respect to FIG. 4) using Support Vector Machine (SVM) Learning Algorithms (LIBSVM) to classify neural data into finger/hand/forearm movements (supination, pronation, hand open, hand closed, and finger flexion).

The finger, hand, and forearm movements (hereafter collectively referred to as “hand movements 350”) may be user-selected for their intuitiveness in representing vehicle driving controls (rightward turning, leftward turning, acceleration, and deceleration, respectively). For example, the BMI training system may include an input program configured to prompt the user 310 to perform a gesture that represents turning right, and the BMI training system may record the manual input and neural cortex brain activity associated with the responsive user input. Decoded hand movements may have been displayed to the user as movements of a hand animation. In another aspect, the BMI training system may include a neuromuscular electrical stimulator system (not shown in FIG. 3) to obtain feedback of neural activity and provide the feedback to the user 310 based on the user's motor intent.

In some aspects, the BMI training system 300 may convert the neural data to a vehicle control command instruction associated with one or more vehicle control functions. In one example embodiment, the BMI training system 300 may match user intention to a fuzzy state associated with a user intention for a vehicle control action. Vehicle control actions may be, for example, steering functions that can include turning the vehicle a predetermined amount (which may be measured, for example, in degrees with respect to a forward direction position), or vehicle functions that can include changing a velocity of the vehicle.

Training the BMI device to interpret the neural data generated by the motor cortex of the user 310 can include receiving, from the data input device (e.g., the microelectrode array 346), a raw signal acquisition comprising decoder values 325 that includes a data feed indicative of a user body gesture 350. In one example training scenario, the user body gesture 350 may include a physical demonstration of a repeating geometric motion, such as drawing (in the air or on a monitor) with an extended finger a circle, an ovaloid, or some other repeating geometric pattern. An example of performing the repeating geometric pattern may include, for example, rotating the wrist to simulate tracing a circle. The BMI training system 300 may obtain the continuous neural data feed from the user 310 performing the user body gesture 350 the repeating geometric motion, generate a correlation model that correlates the continuous neural data feed to a neural gesture emulation function.

In another example embodiment, in lieu of a repeating geometric pattern, the body gesture 350 may include holding a constant gesture, which may mitigate fatigue. An example of a constant gesture may be touching the thumb to the pinky fingertip, flexing a particular finger while curling a second one or more fingers, etc. As with the repeating geometric pattern input, the BMI training system 300 may obtain the continuous neural data feed from the user 310 performing the user body gesture 350, and generate a correlation model that correlates the continuous neural data feed to a neural gesture emulation function.

FIGS. 3B, 3C, 3D, and 3E illustrate a training session using The BMI training system 300, where the user 310 performs the user body gesture 350 that includes a repeating geometric pattern, in accordance with the present disclosure. In one aspect, the user body gesture 350 may include a physical output that includes drawing or otherwise representing a closed geometric shape 358 with an extended digit of the user's hand 365. The closed geometric pattern may be any shape, but ideally one that can be readily repeated both physically and by mental abstraction, such as a circle, oval, rectangle, or some other closed shape.

The closed geometric shape may be complex in that it matches a canonical model 360 for the respective shape. The canonical model 360 may be defined by the user 310, or may be an existing shape which the user must attempt to copy using manual input (e.g., with an extended finger, by moving in the air, tracing on a digitizer, or by some other method of input).

Matching may include an input that is coterminous with the canonical model within a threshold amount of error, and/or meets another guideline or threshold such as being a closed shape, being approximately circular, ovular, or some other predetermined requirement(s).

The complex input sequence (e.g., the complex gesture) may be in the form of a rotary input where the user traces a path in the air, or on a touchscreen or other digitizing input device, where the input creates the repeating geometric pattern 355 that traverses a minimum angle threshold (such that the shape is not too small). The app may provide feedback to the user in the form of audible, haptic, and/or visual feedback, to assist the user 310 to perform the canonical input. For example, when the user touches a digitizing input device (not shown on FIG. 3A), or begins simulation of the gesture in the air, a text and/or a voice may say “provide rotary input as shown on the screen” where an output on the display device 340 (as shown on FIG. 3A) draws an approximation 345 of the user's simulated input motion 345.

As described herein, the user body gesture 350 that includes the repeating geometric pattern 355 can include performance of a complex gesture. The user body gesture 350 may be “complex” in that it matches and/or approximates a canonical model 360 for a particular shape. A canonical model 360 may include geometric information associated with the closed geometric shape 358. The BMI device 108 may match the repeating geometric pattern 355 to the canonical model 360 to determine that the user 310, when operating the vehicle using the BMI system 107, is demonstrating an adequate level of attention to the operation being performed at the user's command. In one aspect, matching can mean that the BMI system 107 determines whether the approximation 345 of a shape defined using the cortical activity of the user 310 (e.g., the approximation 345) matches the canonical model 360 by comparing the canonical model 360 and the path of the approximated shape drawn using mental abstraction, to determine whether the two shapes share, for example, the same pixels, or share some other common attribute that demonstrates mental acuity while simulating drawing the approximated shape in the user's mind. Matching may further include comparing a value for error between the canonical model and the approximated shape drawn by mental abstraction, within a threshold amount of error (determined, in one example, by a linear distance between the theoretical or canonical model and the shape input by the user 310).

In the example shown in FIG. 3B, The BMI training system 300 may digitize the motion associated with the user 310 manual input (e.g., the user body gesture 350). At step 375, as shown in relation to FIG. 3C, The BMI training system 300 may record repeated iterations of the manual input by approximating coordinate information associated with the user body gesture 350. For example, The BMI training system 300 may digitize an approximate location of the user's extended fingertip 366 such that the path of the fingertip 366 creates the closed geometric shape 358.

At step 380, as shown in relation to FIG. 3D, The BMI training system 300 may obtain a continuous neural data feed from the user as the user 310 performs the repeated iterations of the manual input (the user body gesture 350). The BMI training system 300 may determine neural activity associated with the canonical model 360 such that the BMI system 107, when using the canonical model 360 for a point of comparison to the approximation 345, can gauge the user engagement with the concurrent activity at hand. Stated in another way, the user 310 may demonstrate user engagement when the user 310 imagines performing the user body gesture 350 using sufficient mental control that the recorded neural activity matches demonstrated focus (within a determined threshold for deviation). The point of comparison may be valid by comparing the observed neural activity to the canonical model 360 associated with the same thoughts and repeating gesture 358, as they were observed and memorialized during the training session(s).

In some aspects, a user may become fatigued after engaging in a semi-autonomous driving function over a prolonged period of time. It is therefore advantageous to provide a baseline gesture reward function that may train the machine learning system to compensate for such fatigue drift in use. The baseline gesture learning may be done in the initial training process. One the user 310 has engaged a semi-autonomous driving function, the system 300 may utilize a reward function to calculate a drift offset for gesture commands. For example, if the user 310 has started performance of the canonical geometry, and sustained the gesture for a period of time, fatigue may be an issue. As such, the system 300 may calculate the neural firing patterns by observing the neural activity from a set of starting states or positions, and observe the firing patterns over time for offset due to mental fatigue. The system 300 may calculate the offset based off an expected value (the canonical geometry, for example), along with a compensation factor that accounts for fatigue drift.

Reinforcement learning is a machine learning technique that may be used to take a suitable action that maximizes reward in a particular situation, such that the machine learns to find an optimal behavior or path to take given a specific situation. More particularly, the system 300 may use a reward function to give a reward if the compensated gesture recognition provides the expected command (such as, for example, completion of the canonical geometry or providing the “go” signal). This reward may enable the BMI training system 300 to include the latest offset data for greater tolerance. Conversely, if the compensated neural output does not generate the expected gesture recognition, the system 300 may reduce the reward function tolerance on gesture recognition, and require the driving feature to pause for a predetermined period of time.

For example, say a change in gesture is considered a state transition, such that changing from a rest position to the automated driving command gesture can have an associated reward for correct transitioning. The system 300 may use the error function defined here to determine if the guess is correct every few samples. I.e. if the motion initially starts as expected, then slowly increases in error that appears within an allowed threshold (as defined by either motion offset or correlation coefficient of neural firing pattern) the system 300 may give positive reward to retain the gesture. After accumulating sufficient reward, the system 300 may add a new gesture state to the decoder to define how the user's gesture deviates after extended use. The added new gesture state may reduce the error function the following time the user does the command to improve user experience.

Conversely, if the error function exceeds the threshold value, the system 300 may apply a negative reward. If this drops below a given threshold the system 300 may then assume the user is not making the intended gesture, and provide notification that gesture is no longer recognized. If the user makes the same incorrect gesture for a given predicted use case (such as, for example, the motive command), the system 300 may inform the user that the system 300 is being updated to take their new behavior as the expected input. This could alternatively be done as prompt as to whether the user would like the system to be trained to their new behavior.

This reward function may ideally take the predicted gesture value, error value, and a previous input history into account in order to dynamically update the system. The predicted gesture value, error value and the input history may be used to establish a feedback system that operates in a semi-supervised fashion. Stated in another way, the system 300 may train the reward function first, then predict the expected behavior to update the model over time, based off the reward score.

FIG. 4 depicts a functional block diagram of vehicle control using the BMI system 107 to perform an example operation. The example operation demonstrated in FIG. 4 includes automated parking, however it should be appreciated that the present disclosure is not limited to parking functions, and other possible vehicle operation functions are possible and contemplated.

The BMI decoder 144 may receive the continuous neural data 405 from the Human-Machine Interface (HMI) device 146. In an example scenario, a user (not shown in FIG. 4) may interface with the HMI device 146 and perform thought control steps consistent with the training procedures described with respect to FIGS. 3A-3E. For example, the user may desire to increase the vehicle speed during the automated parking operation, where the DAT controller 245 performs most aspects of steering, vehicle speed, starting, stopping, etc., during the automated parking procedure, and the user desires to speed up the operation. The BMI decoder 144 may receive the continuous neural data 405 feed, and decode the continuous neural data using a neural data feed decoder 410. The neural data feed decoder 410 can include the correlation model generated using the BMI training system 300, described with respect to FIGS. 3A-3E.

In one aspect the neural data feed decoder 410 may decode the continuous neural data 405 to determine an intention of the user by matching pattern(s) in the continuous neural data 405 to patterns of the user's neural cortex activity observed during the training operation of FIG. 3A. For example, the continuous neural data may be indicative of a parking motion forward function 450 of a plurality of parking functions 440. More particularly, the system 300 may prompt the user to first select the parking orientation (for example, which slot amongst a plurality of possible slots, a selection of a forward command vs a reverse command, etc.) and the input may be a “proceed” command. Other possible functions, for example, can include a parking motion reverse function 455, a full stop function 460, and/or a full automation function 465 that indicates to the DAT controller 245 that the user intends for the AV controller to perform all aspects of the parking operation. The neural gesture emulation functions 435 can also include continuous input correction functions using the correlation model output described with respect to FIGS. 3B-3E. The continuous input correction function 445 can include an attention checking function 470, and a drift calibration function 475.

In automatic an example procedure that includes automated vehicle navigation for trailer hitch assistance, the user may select a particular trailer amongst a plurality of possible trailers to be the target, and provides the same “proceed” command, as well as being prompted for automated lane change a prompt to change will be given for the user to confirm with a gesture. The automated lane change confirmation may be a one-time command in lieu of a continuous command.

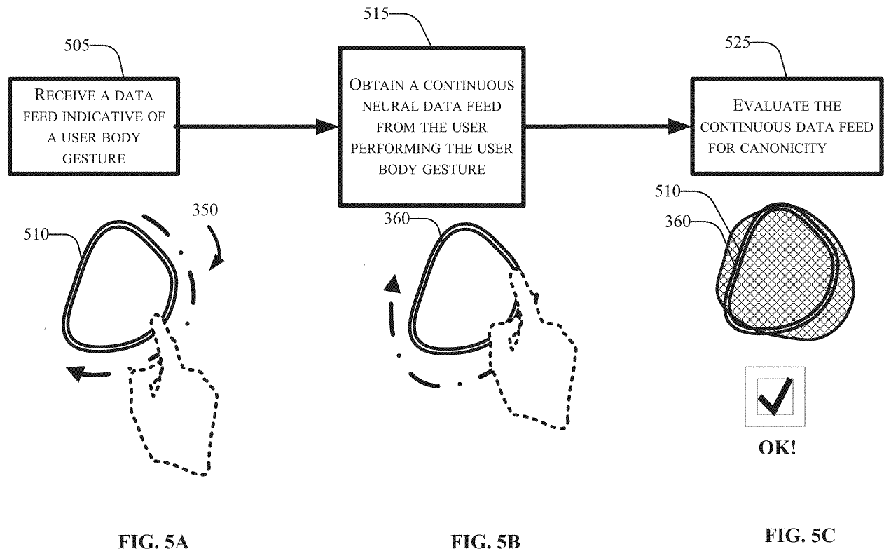

The DAT controller 245 may be configured to provide governance of the overall vehicle operation control, such that rules are implemented that force compliance with rules that may govern situational awareness, vehicle safety, etc. For example, the DAT controller 245 may only allow some commands indicative of speed change that comport with set guidelines. For example, it may not be advantageous to exceed particular speed limits in certain geographic locations, at certain times of day, etc. Accordingly, the DAT controller 245 may receive the control instruction associated with the user intention, and govern whether that requested state may be executed based on the user intention. The DAT controller 245 may control the execution of the parking functions 440, and make the governance decision based on geographic information received from a vehicle GPS, time information, date information, a dataset of rules associated with geographic information, time information, date information, etc. Other inputs are possible and are contemplated. Responsive to determining that a particular intention for a state change is permissible, the BMI device 108 and/or the DAT controller 245 may determine that the user is attentive using an attentive input determination module 420. FIGS. 5A-5C depict steps to form such a determination, as performed by the attentive input determination module 420 (hereafter “determination module 420”), according to an embodiment.

As the user operates the vehicle, the user may perform a mental abstraction of the user body gesture 350 by imagining performance of the closed geometric shape (358 as depicted in FIGS. 3B-3E). At step 505, the attentive input determination module 420 may receive a data feed indicative of a user body gesture. More particularly, the data feed may indicate the user's mental abstraction of performing the user body gesture 350.

At step 515, the attentive input determination module 420 may obtain a continuous neural data feed from the user performing the user body gesture. The attentive input determination module 420 may, at step 525, evaluate the continuous data feed for canonicity. The determining step can include various procedures including, for example, responsive to determining that the digital representation comprises the closed trajectory, determine that the digital representation is coterminous with a canonical geometry within a threshold value for overlap, then determine that the user engagement value exceeds the threshold value for user engagement responsive to determining that the digital representation is coterminous with the canonical geometry.

In another aspect, the input determination module 420 may receive a user input that includes a predetermined “go” gesture, which may signal an intent to proceed. Responsive to receiving a predetermined “resting” gesture, the input determination module 420 may pause a current driving operation.

Returning attention again to FIG. 4, once the attentive input determination module 420 determines that the user engagement value exceeds the threshold value for user engagement, the DAT controller 245 may generate a control instruction 480 for vehicle parking, or some other operational task. The control instruction 480 may be executed by the VCU 165. For example, the VCU 165 may execute the vehicle control function based on the user engagement value exceeding the threshold for user engagement.

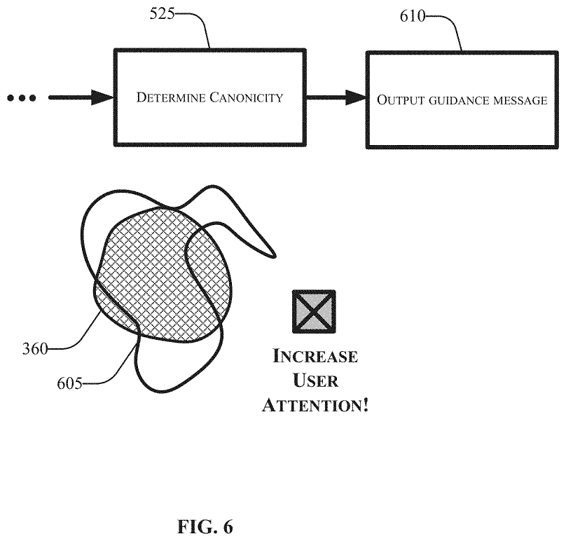

Returning to FIG. 5, at step 525, after the attentive input determination module 420 evaluates the continuous data feed for canonicity, the attentive input determination module 420 may determine that the digital representation is not coterminous with the canonical geometry within a threshold value for overlap. FIG. 6, for example, illustrates such a determination. The attentive input determination module 420 may compare a digital representation 605 of the repeating geometric pattern, but determine that the digital representation 605 does not demonstrate user attention. For example, the approximation may not match the canonical model 360 using various possible metrics for measurement. Responsive to determining that the digital representation 605 is not coterminous with the canonical model 360, the BMI system 107 may output guidance message(s) 610 that prompts the user for increased attention to the task at hand, or provide an indication that the DAT controller 245 is no longer receiving appropriate input from the user's thought control of the BMI system 107.

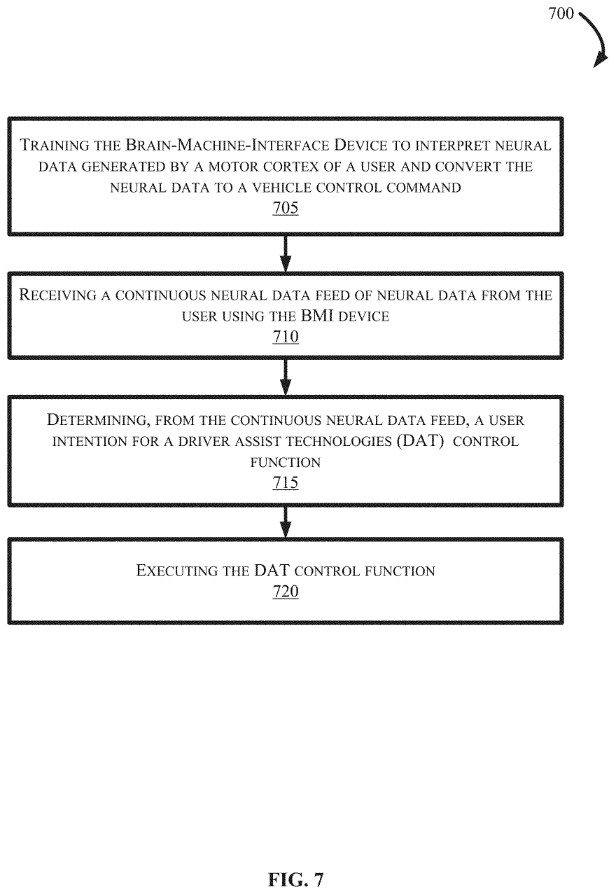

FIG. 7 is a flow diagram of an example method 700 for controlling a vehicle using the BMI system 107, according to the present disclosure. FIG. 7 may be described with continued reference to prior figures. The following process is exemplary and not confined to the steps described hereafter. Moreover, alternative embodiments may include more or less steps than are shown or described herein, and may include these steps in a different order than the order described in the following example embodiments.

At step 705, the method 700 may commence with training the BMI device to interpret neural data generated by a motor cortex of a user's brain and convert the neural data to a vehicle control command.

Next, the method includes a step 710 of receiving a continuous neural data feed of neural data from the user using the trained BMI device.

At step 715, the method 700 may further include the step of determining, from the continuous neural data feed, a user intention for an autonomous vehicle control function.

At step 720, the method includes executing the vehicle control function.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A computer-implemented method for controlling a vehicle, using a brain machine interface (BMI) device, comprising:
training the BMI device to interpret neural data generated by a motor cortex of a user and correlating the neural data to a vehicle control command associated with a neural gesture emulation function;
receiving a continuous data feed of neural data from the user using the BMI device;
determining, from the continuous data feed of neural data, a user intention for a vehicle control function; and
executing the vehicle control function.

2. The computer-implemented method according to claim 1, wherein the vehicle control function comprises an instruction for vehicle parking.

3. The computer-implemented method according to claim 1, wherein executing the vehicle control function comprises:
executing an aspect of automated vehicle parking, via an AV controller, based on the neural gesture emulation function associated with the user intention.

4. The computer-implemented method according to claim 1, further comprising:
evaluating the continuous data feed of neural data to determine a user engagement value associated with the user intention; and
executing the vehicle control function responsive to determining that the user engagement value exceeds a threshold for user engagement.

5. The computer-implemented method according to claim 4, wherein training the BMI device to interpret the neural data generated by the motor cortex of the user comprises:
receiving, from a data input device, a data feed indicative of a user body gesture of a repeating geometric motion;
obtaining a continuous neural data feed from the user performing the user body gesture repeating the repeating geometric motion; and
generating a correlation model that correlates the continuous neural data feed to the neural gesture emulation function.

6. The computer-implemented method according to claim 5, further comprising executing the neural gesture emulation function based on the user engagement using the correlation model.

7. The computer-implemented method according to claim 4, wherein evaluating the continuous data feed of neural data to determine the user engagement value associated with the user intention for the vehicle control function comprises:
generating, from the continuous data feed of neural data, a digital representation of a repeating body gesture performed by the user;
determining that the digital representation comprises a closed trajectory;
responsive to determining that the digital representation comprises the closed trajectory, determining that the digital representation is coterminous with a canonical geometry within a threshold value for overlap;
determining that the user engagement value exceeds the threshold value for user engagement responsive to determining that the digital representation is coterminous with the canonical geometry; and
executing the vehicle control function based on the user engagement value exceeding the threshold for user engagement.

8. The computer-implemented method according to claim 7, further comprising:
determining that the user engagement value does not exceed the threshold for user engagement; and
outputting a message indicating a suggestion associated with user engagement.

9. The computer-implemented method according to claim 1, wherein the vehicle control function is associated with a set of Gaussian kernel-type membership functions.

10. The computer-implemented method according to claim 9, wherein a control function member of the set of Gaussian kernel-type membership functions comprises a control command for automatically parking the vehicle.

11. A brain machine interface (BMI) system for controlling a vehicle, comprising:
a processor; and
a memory for storing executable instructions, the processor configured to execute the instructions to:
receive, by way of a BMI input device, a continuous data feed of neural data from a user using the BMI device;
determine, from the continuous data feed of neural data, a user intention for a semi-autonomous vehicle control function; and
execute the semi-autonomous vehicle control function.

12. The BMI device according to claim 11, wherein the vehicle control function comprises an instruction for vehicle parking.

13. The BMI device according to claim 12, wherein the processor is further configured to:
execute an aspect of automated vehicle parking, via a driver assistance controller, based on a neural gesture emulation function associated with the user intention.

14. The BMI device according to claim 13, wherein the processor is further configured to:
evaluate the continuous data feed of neural data to determine a user engagement value associated with the user intention; and
execute the vehicle control function responsive to determining that the user engagement value exceeds a threshold for user engagement.

15. The BMI device according to claim 14, wherein the processor is further configured to execute the instructions to:
receive, from a data input device, a data feed indicative of a user body gesture of a repeating geometric motion;
obtain a continuous neural data feed from the user performing the user body gesture of the repeating geometric motion; and
generate a correlation model that correlates the continuous neural data feed to the neural gesture emulation function.

16. The BMI device according to claim 15, wherein the processor is further configured to execute the instructions to:
execute the neural gesture emulation function based on the user engagement using the correlation model.

17. The BMI device according to claim 14, wherein the processor is further configured to execute the instructions to:
generate, from the continuous data feed of neural data, a digital representation of a repeating body gesture performed by the user;
determine that the digital representation comprises a closed trajectory;
responsive to determining that the digital representation comprises the closed trajectory, determine that the digital representation is coterminous with a canonical geometry within a threshold value for overlap;
determine that the user engagement value exceeds the threshold value for user engagement responsive to determining that the digital representation is coterminous with the canonical geometry; and
execute the vehicle control function based on the user engagement value exceeding the threshold for user engagement.

18. The BMI device according to claim 17, wherein the processor is further configured to execute the instructions to:
determine that the user engagement value does not exceed the threshold for user engagement; and
output a message indicating a suggestion associated with user engagement.

19. The BMI device according to claim 11, wherein the vehicle control function is associated with a set of Gaussian kernel-type membership functions, the vehicle control function comprising a control command for automatically parking the vehicle.

20. A non-transitory computer-readable storage medium in a brain machine interface (BMI) device, the computer-readable storage medium having instructions stored thereupon which, when executed by a processor, cause the processor to:
receive, by way of a BMI input device, a continuous data feed of neural data from a user of the BMI device;
determine, from the continuous data feed of neural data, a user intention for a vehicle control function; and
execute the vehicle control function.
